(19) United States
(12) Patent Application Publication
(10) Pub. No.: US 2006/0025074 A1
(43) Pub. Date: Feb. 2, 2006

(54) Bluetooth-based headset

(76) Inventors: Chih-Ming Liang, Taichung City (TW); Ming-Te Chen, Taichung City (TW)

Correspondence Address: Chih-Ming Liang, 7F. ,No. 213, Civic Boulevard. Sec. 4, Taipei, 105, TW

(21) Appl. No.: 10/902,638

(22) Filed: Jul. 30, 2004

(51) Int. Cl. H04M 1/00

(52) U.S. Cl. 455/41.2; 455/550.1

(57) ABSTRACT

A Bluetooth-based headset includes at least a Bluetooth module, to which a wireless receiving/transmitting circuit having an antenna, a battery, a microphone, a speaker, an input/output control circuit, and a USB interface having a USB connector and a charging circuit connected to the battery are connected. The Bluetooth module is internally provided with a mechanism for switching the Bluetooth module between different signal processing modes. The switching mechanism is adapted to detect pins of the USB connector, and switch the Bluetooth module to a Dongle mode for uploading/downloading data or to a Headset mode, depending on changes in a potential of the pins of the USB connector. In this manner, a mobile phone and a computer could be wirelessly connected via the Bluetooth-based headset to transmit data between them.

### FIELD OF THE INVENTION

The present invention relates to a Bluetooth-based headset, and more particularly a Bluetooth-based headset that wirelessly connects a mobile phone to a computer, so that data could be transmitted between the mobile phone and the computer.

### BACKGROUND OF THE INVENTION

Bluetooth is a wireless transmission technique that enables short-distance wireless connection between desktop/laptop computers, personal data assistants (PDA), mobile phones, printers, scanners, digital cameras, and even electrical household appliances.

Bluetooth (chip set) transmits data and voice signals using frequencies in ISM band. Every Bluetooth-based device or apparatus has a standard address for a user to enable one-to-one or one-to-seven (small-scaled network) connection using low-power radio, with a maximum transmission range of ten meters. The Bluetooth not only provides a transmission rate as high as 1 MB/sec, but also allows encryption using pin codes.

Since the Bluetooth-based device has a hopping rate as high as 1600 hops/second, it is not easily intercepted and interrupted by electromagnetic waves.

The Bluetooth technique is developed in an attempt to replace the wiring required by various apparatus. It enables different electronic apparatus, such as mobile phones, printers, notebook computers, desktop computers, PDAs, etc., to be wirelessly connected for communication between them, and may have a band width as wide as 1 Mbps.

The Bluetooth technique is also modulated to have power consumption as low as possible. Almost all the Bluetooth-based apparatus are battery-driven. That is why the Bluetooth technique could have only very limited value power supply for use and must be designed to be power saving. This condition inevitably reduces the effective working range of the Bluetooth-based apparatus. That is, while the Bluetooth-base apparatus complies with power-saving class 2 and requires only 3˜30 mA for transmission, it has a transmission distance no more than ten meters.

With the above-mentioned application advantages and scopes, a Bluetooth-based device actually meets requirements for a conventional wireless headset. As a result, a Bluetooth-based headset is developed. The Bluetooth technique is superior to infrared transmission in that it employs broadcast technique and enables wireless connection even to an invisible location. Therefore, a user may position a mobile phone in a pocket when the mobile phone is on-line.

However, the Bluetooth technique is not so popular, and only a few types of mobile phones, printers, and notebooks have a built-in Bluetooth interface. Bluetooth-based expansion module for use with a desktop or notebook computer usually has a price between US$90.00˜250.00, which is quite expensive for general consumers.

It is therefore desirable to develop a Bluetooth-based headset that is adapted to serve as a medium between a mobile phone and a computer to enable data transmission therebetween; so as to reduce the user's expenditure and give the Bluetooth-based headset a new function.

### SUMMARY OF THE INVENTION

A primary object of the present invention is to provide a Bluetooth-based headset that wirelessly connects a mobile phone to a computer, so that data could be transmitted between the mobile phone and the computer.

To achieve the above and other objects, the Bluetooth-based headset according to the present invention mainly includes at least a Bluetooth module, to which a wireless receiving/transmitting circuit having an antenna, a battery, a microphone, a speaker, an input/output control circuit, and a USB interface having a charging circuit connected to the battery and a USB connector are connected. The Bluetooth module is internally provided with a mechanism for switching the Bluetooth module between different signal processing modes. The switching mechanism is adapted to detect pins of the USB connector, and switch the Bluetooth module to a Dongle mode for uploading/downloading data or to a Headset mode, depending on changes in a potential of the pins of the USB connector. In this manner, a mobile phone and a computer could be wirelessly connected via the Bluetooth-based headset to transmit data between them.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a Bluetooth-based headset according to an embodiment of the present invention;

FIG. 2 is a block diagram showing internal circuits of the Bluetooth-based headset of the present invention;

FIG. 3 shows an example of use of the present invention; and

FIG. 4 shows another example of use of the present invention.

### DETAILED DESCRIPTION OF THE PREFERRED EMBODIMENTS

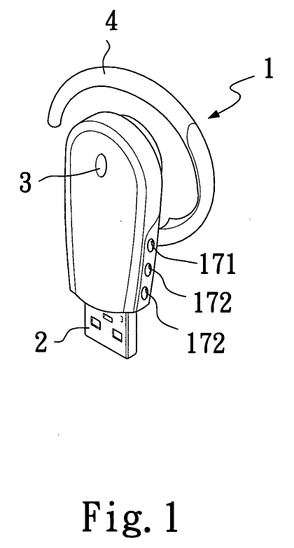

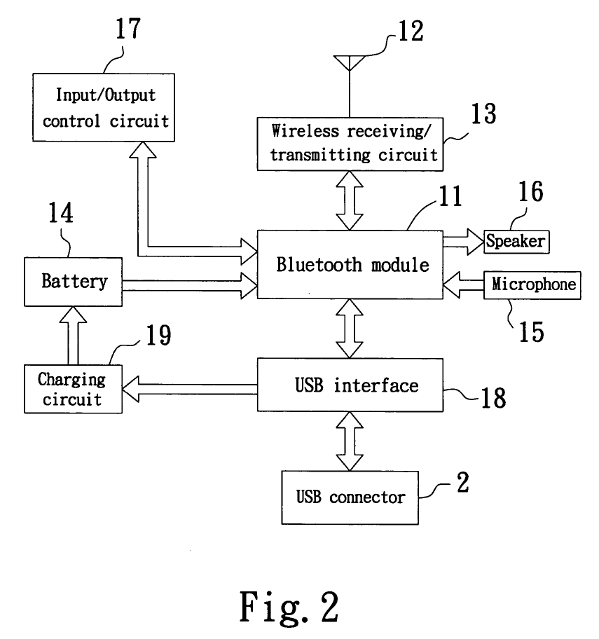

Please refer to FIG. 1 that is a perspective view of a Bluetooth-based headset 1 according to an embodiment of the present invention, and to FIG. 2 that is a block diagram showing internal circuits of the headset 1. As shown, the Bluetooth-based headset 1 includes at least a Bluetooth module 11, to which a wireless receiving/transmitting circuit 13 with an antenna 12, a rechargeable battery 14, a microphone 15, a speaker 16, an input/output control circuit 17 connected to an answer/hang-up key 171 (see FIG. 1), a volume control key 172 (see FIG. 1), and a power switch (not shown) externally provided on the Bluetooth headset 1, and a USB interface 18 having a USB connector 2 and a charging circuit 19 connected to the battery 14 are connected.

The Bluetooth module 11 is internally provided with a mechanism for switching the module 11 between different signal processing modes. The signal processing mode switching mechanism is adapted to detect pins of the USB connector 2, and switch the module 11 to a Dongle mode for uploading/downloading data or to a Headset mode, depending on changes in the potential of the pins of the USB connector 2. When a high potential is detected, the module 11 is switched to the Dongle mode. Moreover, when the pins of the USB connector 2 are at a high potential, the charging circuit 19 will charge the battery 14 to supply the Bluetooth-based headset 1 with working voltage needed for normal operation thereof. Reversely, when the pins of the USB connector 2 are at a low potential, the module 11 is switched to the Headset mode. Alternatively, when a low potential is detected, the module 11 is switched to the Dongle mode and the charging circuit 19 charges the battery 14 to supply the Bluetooth-based headset 1 with working voltage needed for normal operation thereof; and reversely, when the pins of the USB connector 2 are at a high potential, the module 11 is switched to the Headset mode. An indicating light 3 may be connected to the charging circuit 19 for clearly indicating a current working state of the charging circuit 19.

The Bluetooth-based headset 1 also includes a C-shaped ear hook 4 for hooking the headset 1 to a user's ear. It is understood the Bluetooth-based headset 1 of the present invention is not necessarily in the configuration shown in FIG. 1, but may be differently designed. And, it is also possible to provide a dust cap (not shown) for fitly covering the USB connector 2. Alternatively, the USB connector 2 may be movably extended from or retracted into the Bluetooth-based headset 1.

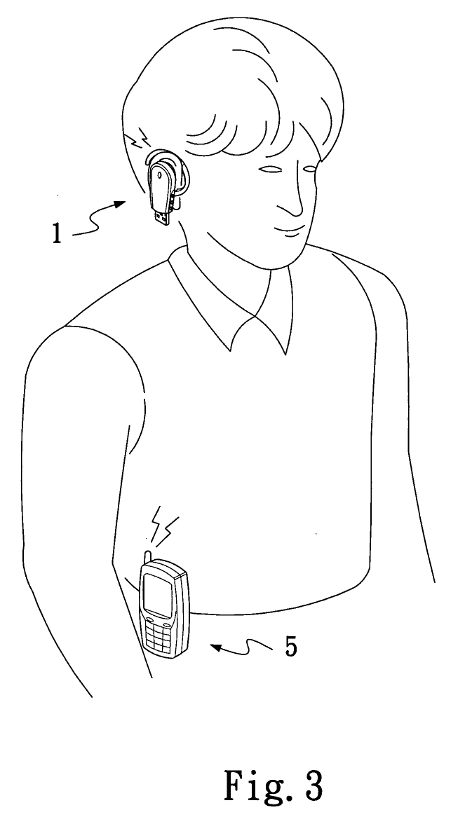

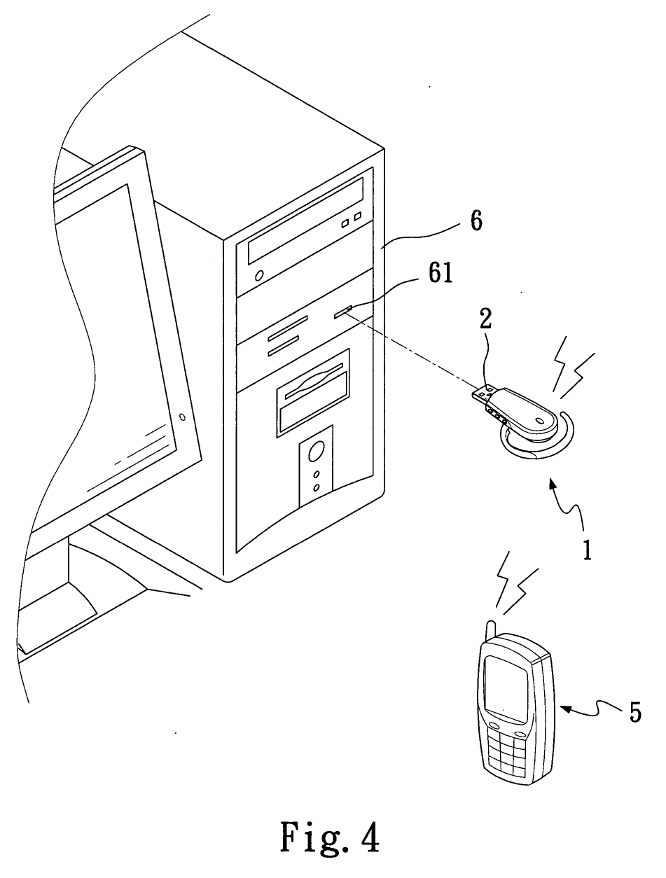

FIGS. 3 and 4 show two examples of use of the present invention. In FIG. 3, the Bluetooth-based headset 1 of the present invention is hooked to a user's ear and serves as a general wireless headset to transmit and receive voice signals to and from a mobile phone 5. In FIG. 4, the Bluetooth-based headset 1 is connected at the USB connector 2 to a USB socket 61 on a computer 6 and serves to transmit data stored in a mobile phone 5, such as digital photos, short messages, etc., to the computer 6 for storage therein, or to download data stored in the computer 6, such as desktop designs, ringing types for incoming calls, etc., to the mobile phone 5. In this manner, the mobile phone 5 and the computer 6 may be wirelessly connected to each other via the Bluetooth-based headset 1 to transmit data between them.

What is claimed is:

1. A Bluetooth-based headset, comprising a Bluetooth module, to which a wireless receiving/transmitting circuit having an antenna, a battery, a microphone, a speaker, an input/output control circuit, and a USB interface having a USB connector and a charging circuit connected to said battery are connected; and
said Bluetooth module being internally provided with a mechanism for switching said Bluetooth module between different signal processing modes; said signal processing mode switching mechanism being adapted to detect pins of said USB connector, and switch said Bluetooth module to a Dongle mode for uploading/downloading data or to a Headset mode, depending on changes in a potential of said pins of said USB connector.

2. The Bluetooth-based headset as claimed in claim 1, wherein said battery comprises a rechargeable battery.

3. The Bluetooth-based headset as claimed in claim 1, wherein said input/output control circuit is connected to an answer/hang-up key, a volume control key, and a power switch externally provided on said Bluetooth-based headset.

4. The Bluetooth-based headset as claimed in claim 1, wherein said charging circuit is adapted to charge said battery when said pins of said USB connector are at a high potential, so as to supply said Bluetooth-based headset with a working voltage needed for a normal operation thereof.

5. The Bluetooth-based headset as claimed in claim 1, wherein said charging circuit is connected to an indicating light for clearly indicating a current working state of said charging circuit.

6. The Bluetooth-based headset as claimed in claim 1, further comprising a dust cap for fitly covering said USB connector.

7. The Bluetooth-based headset as claimed in claim 1, wherein said USB connector is movably extendable from and retractable into said Bluetooth-based headset.

8. The Bluetooth-based headset as claimed in claim 1, wherein said Bluetooth-based headset is provided with a C-shaped ear hook for hooking to a user's ear.

9. The Bluetooth-based headset as claimed in claim 1, wherein said signal processing mode switch mechanism switches said Bluetooth module to said Dongle mode when said pins of said USB connector are detected as high, and to said Headset mode when said pins of said USB connector are detected as low.

10. The Bluetooth-based headset as claimed in claim 1, wherein said signal processing mode switch mechanism switches said Bluetooth module to said Dongle mode when said pins of said USB connector are detected as low, and to said Headset mode when said pins of said USB connector are detected as high.
